(19) United States
(12) Patent Application Publication
(10) Pub. No.: US 2002/0195861 A1
(43) Pub. Date: Dec. 26, 2002

(54) Armrest device

(76) Inventor: Wan-Chen Lee, Jai Pao City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/888,808

(22) Filed: Jun. 25, 2001

(51) Int. Cl. B60N 2/46; A47C 7/54

(52) U.S. Cl. 297/411.2

(57) ABSTRACT

An armrest device has an armrest frame and a cover plate. The armrest frame has a narrow rear portion and a narrow bottom portion. The cover plate encloses the narrow rear portion and the narrow bottom portion of the armrest frame. A plurality of positioning holes are formed on the narrow rear portion and the narrow bottom portion of the armrest frame. A plurality of washers are inserted in the positioning holes of the armrest frame. The cover plate has a plurality of hollow sockets inserted in the positioning holes of the armrest frame. A plurality of bolts are inserted through the hollow sockets and the positioning holes of the armrest frame.

### BACKGROUND OF THE INVENTION

The present invention relates to an armrest device. More particularly, the present invention relates to an armrest device which has a cover plate having a various color or a various material.

Referring to FIG. 1, a conventional armrest 1 has an upper portion 10, a front portion 20, a bottom portion 40, and a rear portion 30. The bottom portion 40 of the conventional armrest 1 and the rear portion 30 of the conventional armrest 1 have narrow and solid shapes. The sizes of the upper portion 10 and the front portion 20 of the conventional armrest 1 are larger than the sizes of the bottom portion 40 and the rear portion 30 of the conventional armrest 1. The upper portion 10, the front portion 20, the bottom portion 40, and the rear portion 30 of the conventional armrest 1 are made in one piece. Therefore, the color and the material of different portions of the conventional armrest 1 cannot be varied.

### SUMMARY OF THE INVENTION

An object of the present invention is to provide an armrest device which has a cover plate having a various color or a various material to decorate the armrest device.

Another object of the present invention is to provide an armrest device which has a cover plate to reinforce a rear portion and a bottom portion of an armrest frame.

Another object of the present invention is to provide an armrest frame which has a narrow rear portion and a narrow bottom portion to lighten a weight of the armrest frame.

Accordingly, an armrest device comprises an armrest frame and a cover plate. The armrest frame has a narrow rear portion and a narrow bottom portion. The cover plate encloses the narrow rear portion and the narrow bottom portion of the armrest frame. A plurality of positioning holes are formed on the narrow rear portion and the narrow bottom portion of the armrest frame. A plurality of washers are inserted in the positioning holes of the armrest frame. The cover plate has a plurality of hollow sockets inserted in the positioning holes of the armrest frame. Each of the hollow sockets has a through hole. A plurality of bolts are inserted through the hollow sockets and the positioning holes of the armrest frame.

### BRIEF DESCRIPTION OF THE DRAWINGS

FIG. 1 is a perspective view of an armrest device of the prior art disposed on a chair;

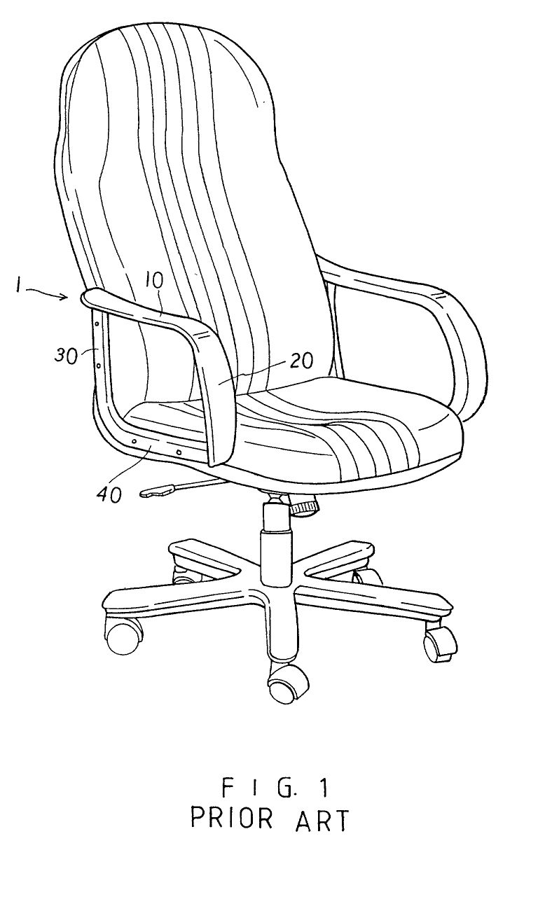

FIG. 2 is a perspective exploded view of an armrest device of a preferred embodiment in accordance with the present invention;

FIG. 3 is a sectional assembly view of an armrest device of a preferred embodiment in accordance with the present invention; and

FIG. 4 is a perspective assembly view of an armrest frame and a cover plate of a preferred embodiment in accordance with the present invention.

### DETAILED DESCRIPTION OF THE INVENTION

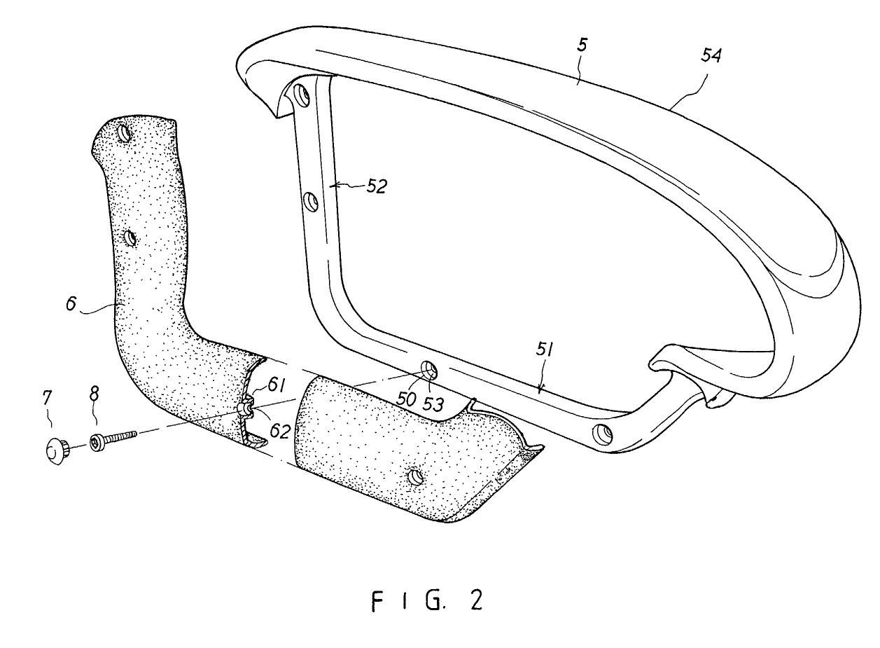

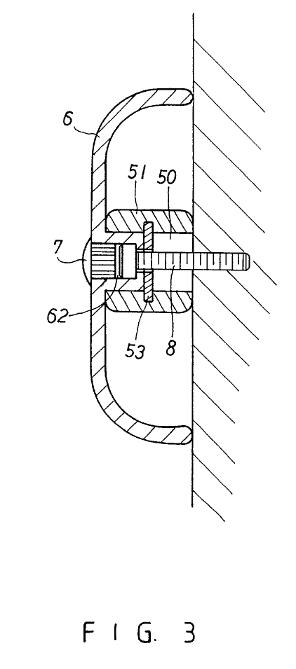

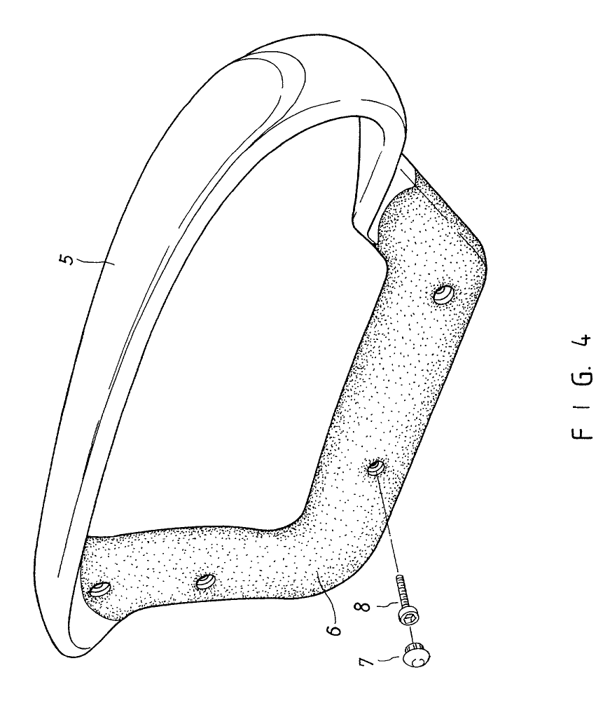

Referring to FIGS. 2 to 4, an armrest device comprises an armrest frame 5 and a cover plate 6.

The armrest frame 5 has a narrow rear portion 52 and a narrow bottom portion 51.

The cover plate 6 encloses the narrow rear portion 52 and the narrow bottom portion 51 of the armrest frame 5.

A plurality of positioning holes 50 are formed on the narrow rear portion 52 and the narrow bottom portion 51 of the armrest frame 5.

A plurality of washers 53 are inserted in the positioning holes 50 of the armrest frame 5.

The cover plate 6 has a plurality of hollow sockets 61 inserted in the positioning holes 50 of the armrest frame 5.

Each of the hollow sockets 61 has a through hole 62.

A plurality of bolts 8 are inserted through the hollow sockets 61 and the positioning holes 50 of the armrest frame 5.

A plurality of cover plugs 7 cover the bolts 8.

A width of an upper portion 54 of the armrest frame 5 is larger than a width of the narrow rear portion 52 of the armrest frame 5.

A width of the narrow bottom portion 51 of the armrest frame 5 is the same as the width of the narrow rear portion 52 of the armrest frame 5.

The width of the narrow rear portion 52 of the armrest frame 5 plus a thickness of the cover plate 6 is the same as the width of the upper portion 54 of the armrest frame 5.

It is an option to vary a color of the cover plate 6 in order to decorate the armrest device.

The invention is not limited to the above embodiment but various modification thereof may be made. Further, various changes in form and detail may be made without departing from the scope of the invention.

I claim:

1. An armrest device comprises:
an armrest frame and a cover plate,
the armrest frame having a narrow rear portion and a narrow bottom portion,
the cover plate enclosing the narrow rear portion and the narrow bottom portion of the armrest frame,
a plurality of positioning holes formed on the narrow rear portion and the narrow bottom portion of the armrest frame,
a plurality of washers inserted in the positioning holes of the armrest frame,
the cover plate having a plurality of hollow sockets inserted in the positioning holes of the armrest frame,
each of the hollow sockets having a through hole, and
a plurality of bolts inserted through the hollow sockets and the positioning holes of the armrest frame.

2. The armrest device as claimed in claim 1, wherein a width of an upper portion of the armrest frame is larger than a width of the narrow rear portion of the armrest frame, and the width of the narrow rear portion of the armrest frame plus a thickness of the cover plate is the same as the width of the upper portion of the armrest frame.

3. The armrest device as claimed in claim 1, wherein a width of the narrow bottom portion of the armrest frame is the same as the width of the narrow rear portion of the armrest frame.
